(19) United States
(12) Patent Application Publication
(10) Pub. No.: US 2002/0018571 A1
(43) Pub. Date: Feb. 14, 2002

(54) Key management methods and communication protocol for secure communication systems

(76) Inventors: Walter F. Anderson, Algonquin, IL (US); Stanley J. Knapczyk, Justice, IL (US); Larry Murrill, Schaumburg, IL (US)

Correspondence Address: MOTOROLA, INC., 1303 EAST ALGONQUIN ROAD, IL01/3RD, SCHAUMBURG, IL, 60196

(21) Appl. No.: 09/938,184

(22) Filed: Aug. 23, 2001

Related U.S. Application Data
(63) Continuation-in-part of application No. 09/387,546, filed on Aug. 31, 1999.
(63) Continuation-in-part of application No. 09/425,816, filed on Oct. 22, 1999.

(51) Int. Cl. H04L 9/00

(52) U.S. Cl. 380/277; 380/273

(57) ABSTRACT

Key management methods and communication protocol adapted to reduce the burden placed upon a key delivery device (e.g., KVL) operator. The KVL (101, 401) receives KMM frames (800) including a target destination field (826) and a key management message field (830). Key management messages (KMMs) to be delivered to various targets are included within the key management message fields. The KVL identifies targets either from target destination identifiers in the target destination field (if the KMM is to be delivered encrypted or “black” transfer to target) or from target destination identifiers in the KMM itself (if the KMM is to delivered unencrypted or “red” transfer to target). The KVL determines candidate devices to be targets if they correspond to the target destination identifiers and if so, the KVL automatically delivers the proper key management messages to the respective targets. Key management messages are not delivered to candidate devices not determined to be targets. Outcomes, e.g., success or failure, of attempted deliveries of key management messages are communicated from the target devices to the KVL, and from the KVL to a key management facility (KMF). The method is useful for first-time rekeying or for ongoing rekeying.

### CROSS-REFERENCE TO RELATED APPLICATIONS

This application is a continuation-in-part of U.S. application Ser. No. 09/387,546, filed Aug. 31, 1999 and U.S. application Ser. No. 09/425,816, filed Oct. 22, 1999.

### FIELD OF THE INVENTION

This invention relates generally to secure communication systems, and more particularly to key management methods for secure communications systems.

### BACKGROUND OF THE INVENTION

Secure communication systems are well known. Police and public safety personnel, for example, often require secure voice and/or data communications between mobile transmitters and receivers, such as in-car mobile or hand-held portable radios (mobiles) as well as fixed transmitters and receivers, such as a central dispatch station. The communication paths between the mobiles and the fixed end are typically wireless links, such as radio frequency (RF) channels. The communication paths between fixed transmitters and receivers are typically wireline links, such as land-based phone lines. Secure communication is made possible by designated transmitters and receivers (hereinafter “encryption devices”) sharing an encryption key that uniquely specifies an encryption algorithm for the communication. Only encryption devices having identical keys are capable of intelligibly reproducing the communication. Each individual encryption device may have more than one key. For example, it is frequently desirable for supervisory radios to have several different keys to communicate with different groups of users each having a different key. The keys are usually changed periodically, typically weekly or monthly to reduce the likelihood that the keys might be obtained by unauthorized parties.

The process of loading encryption keys into the encryption devices, called rekeying, can be accomplished in a variety of ways. Manual rekeying is the act of physically making contact between a key delivery device (e.g., Key Variable Loader, or KVL) and a target encryption device in order to deliver one or more encryption keys to the device. In most cases, the key delivery device (e.g., KVL) is a priori configured by a security officer and then placed in the hands of a field operator to carry out the rekeying process. The field operator typically plugs a cable from the KVL to the target encryption device, then presses the appropriate buttons on the KVL to download the keys into the memory of the target device.

It will be appreciated that there are a number of security challenges associated with a manual rekeying scheme. These challenges include knowing which ones of the encryption devices are to be rekeyed, knowing which keys are to be delivered to which encryption devices, and keeping track of the success, failure or completeness of each individual rekeying operation. These challenges are especially evident when differing sets of multiple keys are to be delivered to multiple radios.

Current systems for manual rekeying place a heavy burden upon the operator. The operator must generally maintain a list of target encryption devices, the list including a designation of which keys are to be delivered to which device. The operator is entrusted to reach every target device on the list, load the correct keys into each target device and record the results. Current schemes generally confirm the results of a rekey with an audible tone or text message at the encryption device and/or key delivery device. Some key delivery devices also create a local log of rekeying activity. However, the problem is that these mechanisms at best provide a record of rekeying activity actually accomplished by the operator—they do not provide a record of rekeying activity for the target units the operator was supposed to rekey. There is no mechanism that would prevent the operator from accidentally rekeying a particular encryption device that should not have been rekeyed or that would prevent the operator from loading the wrong keys into a particular encryption device.

Centralized key management systems, such as Over-The-Air Rekeying (OTAR) systems, accomplish rekeying by transmitting the encrypted keys from a centralized Key Management Facility (KMF). The keys may be transmitted either individually or simultaneously to multiple encryption devices over a typical encrypted communication channel. Generally, a centralized rekeying system can accomplish rekeying in less time and with greater security than with manual rekeying. However, centralized key management systems are known to require a number of configuration steps upon initial set-up or upon fault recovery of the system.

First, an initial encryption key must be established between the KMF and each of the various encryption units to enable secure, remote and wireless delivery of subsequent encryption keys. This initial encryption key is usually established manually, for example, by loading the key into the encryption units with a manual key delivery device (e.g., KVL). Manual rekeying upon initial set-up of a centralized key management system presents generally the same security challenges as an ongoing manual rekeying scheme.

Second, a number of parameters including source and destination IDs (identifications) or addresses must be identified to establish the communications link between the KMF and the various encryption units for subsequent rekeying messages. At the KMF, a database records the IDs of each encryption unit and identifies which units need/have what keys. The source/destination IDs are then manually programmed into each of the various encryption units. In practice, therefore, several parameters for what can be several thousand subscriber units must be identically entered in different places, typically at different times and by different people. Clearly, this step is an expensive, error-prone and time-consuming burden.

Accordingly, there is a need for a key management system, either in an ongoing manual rekeying scheme or upon initial set-up or fault recovery of a centralized key management system, that reduces the burdens placed upon the key delivery device operator in performing rekeying activity. Preferably, the system will prevent the operator from accidentally rekeying a particular encryption device that should not have been rekeyed, will prevent the operator from loading the wrong keys into a particular encryption device and will provide for automatically recording the success or failure of rekeying activity. Advantageously, the system will support both encrypted (“black transfer to target”) and unencrypted (“red transfer to target”) modes of delivering rekeying messages to the target encryption devices.

There is further a need to define a protocol for the formation and exchange of messages, including key management messages, which protocol allows for the exchange of key management messages between a KVL and one or more target devices. Preferably, the protocol should allow for exchanging messages between a KVL and one or more of a mobile or portable encryption device (e.g., radio), digital interface unit, encryption management controller, radio network controller or key management facility. The protocol should be usable in a manual or store-and-forward rekeying system. The protocol should also allow for the encryption of the key management message(s).

Under normal circumstances, with the exception of the first key delivered to a target, it is desirable to transfer rekeying messages in an encrypted black transfer to target (“Black”) mode to enhance security. In Black mode, the messages are encrypted during delivery and the target devices will usually have the appropriate encryption key(s) to process the messages. However, there are some circumstances where the target device may not have the proper key(s), or where the KMF records may get out of sync with the target devices causing a key mismatch, resulting in a failure to deliver the key management messages. In such case, it would be desirable to detect the failures as they happen and to flag the respective devices so that the KMF knows which device(s) need updated keys. Then, the proper keys may be delivered to the devices in a red transfer to target mode.

The present invention is directed to satisfying or at least partially satisfying the aforementioned needs.

### BRIEF DESCRIPTION OF THE DRAWINGS

The foregoing and other advantages of the invention will become apparent upon reading the following detailed description and upon reference to the drawings in which:

FIG. 1 is a diagram illustrating a key delivery device connected to an encryption device according to one embodiment of the present invention;

FIG. 2 is a block diagram of the key delivery device of FIG. 1;

FIG. 3 is a flowchart of a rekeying method using a key delivery device according to one embodiment of the present invention;

FIG. 4 is a diagram illustrating a key management facility connected to a key delivery device according to one embodiment of the present invention;

FIG. 5 is a flowchart identifying steps of a rekeying method performed by a key management facility according to one embodiment of the invention;

FIG. 6 is a flowchart identifying steps for initial configuration of a centralized key management system according to one embodiment of the invention;

FIG. 7 is a flowchart showing a protocol for the formation and exchange of messages in accordance with the invention;

FIG. 8 is a bit field representation of a KMM frame in accordance with the invention;

FIG. 9 is a flowchart showing formation of a KMM frame in accordance with the invention;

FIG. 10 is a bit field representation of a KMM Status frame in accordance with the invention;

FIG. 11 is a flowchart showing formation of a KMM Status frame in accordance with the invention; and

FIG. 12 illustrates an example message exchange sequence between a KVL and a target in accordance with the invention.

### DESCRIPTION OF PREFERRED EMBODIMENTS

The following describes a key management system and communication protocol usable in an ongoing manual rekeying scheme or upon initial set-up or fault recovery of a centralized key management system that reduces the burdens placed upon the key delivery device operator in performing rekeying activity. The system and protocol prevent the operator from accidentally rekeying a particular encryption device that should not have been rekeyed, prevent the operator from loading the wrong keys into a particular encryption device and provides for automatically recording the success or failure of rekeying activity. The system and protocol will support both encrypted (“black transfer to target”) and unencrypted (“red transfer to target”) modes of delivering rekeying messages to the target encryption devices. The system provides for setting up a centralized key management system without manually programming source and destination ID's into the various encryption units.

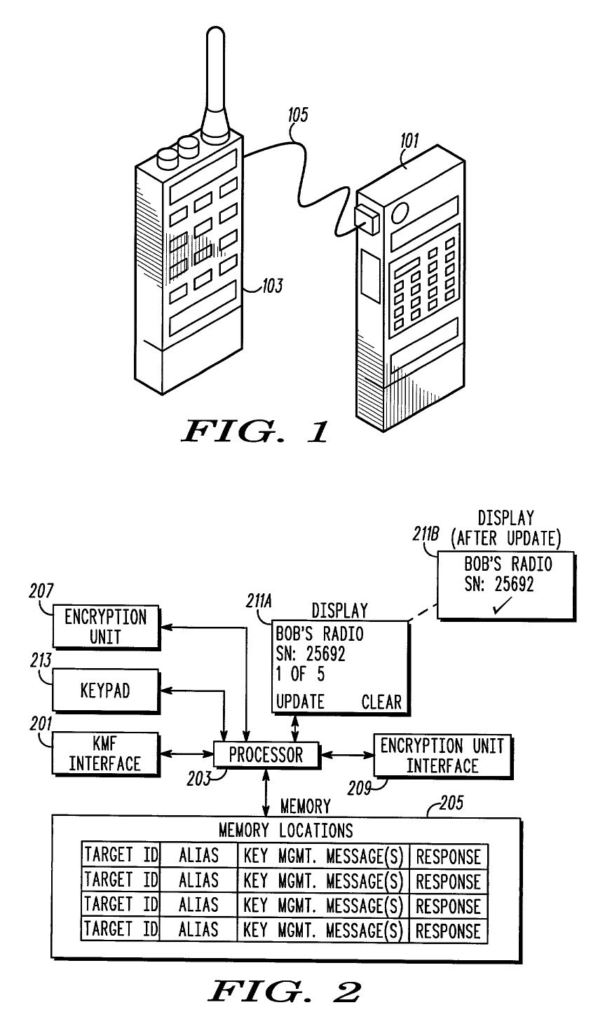

Turning now to the drawings and referring initially to FIG. 1, there is shown a key delivery device 101 connected to an encryption device 103. In one embodiment, the key delivery device 101 is a key variable loader (KVL) such as a KVL 3000, available from Motorola, Inc. and the encryption device 103 is a mobile radio, such as an ASTRO Spectra mobile radio, available from Motorola, Inc. As shown in FIG. 1, a cable 105 connects the key delivery device 101 to the encryption device 103 so that key management messages may be communicated from the key delivery device 101 to the encryption device 103. It will be appreciated, however, that wireless communications or other suitable means might be used to communicate key management messages from the key delivery device 101 to the encryption device 103. The key management messages may comprise rekeying messages supplying a selected one or more encryption keys to the encryption device 103.

FIG. 2 is a block diagram of the key delivery device 101 according to one embodiment of the invention. For convenience, the key delivery device 101 will hereinafter be referred to as the KVL. A KMF interface 201 (e.g., telephone line) allows for the KVL to be operably connected to a centralized key management facility, or KMF (not shown). An encryption unit interface 209 (e.g., cable) allows for the KVL to be operably connected to various encryption units. In one embodiment, the KMF communicates key management messages to the KVL that are to be delivered to specific encryption units. For example, encrypted rekeying messages destined for specific encryption units may be created at the KMF and securely downloaded to the KVL via the KMF interface 201. For convenience, those encryption units that are targeted by the KMF to receive messages will hereinafter be referred to as “target units.”

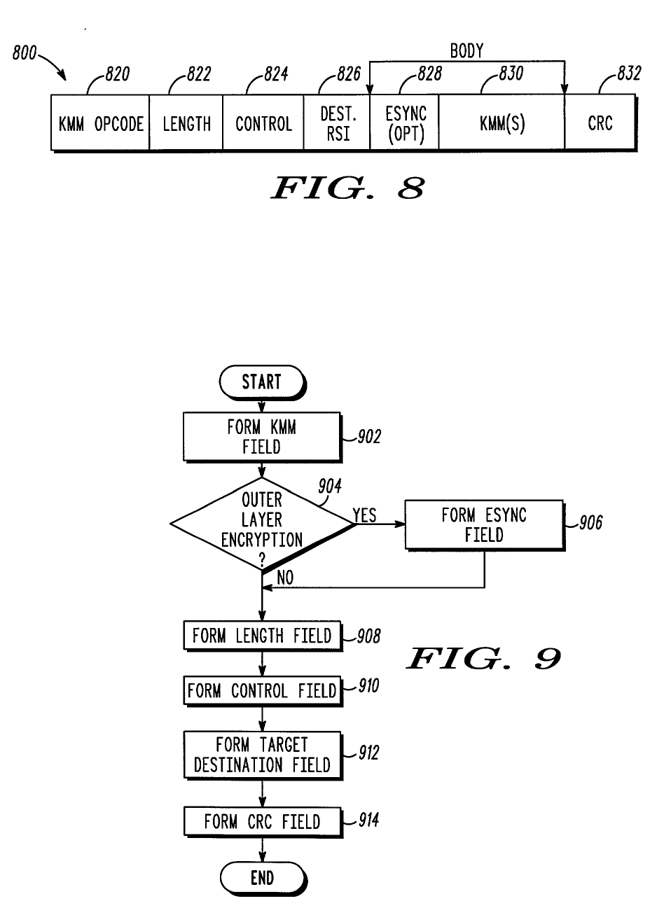

The KMF communicates information to the KVL identifying the various target units and identifying which messages are to be delivered to the target units. In effect, the aggregate of information defines a “record” that is communicated to the KVL. Thus, for convenience, the term “record” will hereinafter be understood to refer to the aggregate of information received by the KVL. In one embodiment, the information (or “record”) is communicated to the KVL on a message by message basis, by sending various key management message frames, as will be described in greater detail in relation to FIG. 8. Alternatively, the information or record may be sent separately from the key management message frames. The record enables the KVL to identify the target units and to associate each of the target units to the key management messages that are to be delivered to those target units. The key management messages may include rekeying messages, in which case the record assures that the right keys will be delivered to the right units. The record may also include an assignment between the target units and one or more key delivery devices.

In one embodiment, in a store and forward operation, the KMF communicates an instruction to the KVL to deliver rekeying messages in either a black store and forward mode or a red store and forward mode. “Black store and forward” refers to the transfer of rekeying messages stored in the KVL to the target unit in a black (encrypted) transfer to target mode. “Red store and forward” refers to the transfer of rekeying messages stored in the KVL to the target unit in a red (unencrypted) transfer to target mode. In an OTAR operation, rekeying messages are communicated to the target device in black transfer to target mode. In one embodiment, the KMF maintains a record of devices that are to be updated via OTAR and/or store and forward techniques, the record advantageously identifying the security level of the update, e.g., red transfer to target mode or black transfer to target mode. For example, the record may be implemented by storing the target devices in a memory (not shown) and “flagging” those target devices that are to be updated in red transfer to target mode with some indicia of the required security level. Alternatively or additionally, the messages associated with the target devices may be flagged. For example, the KMF may employ a “Needs Service” flag to indicate those devices that need service and thereby require an update in red transfer to target mode.

The communication of an “instruction,” as used herein, shall be understood to encompass both direct and indirect instructions. For example, in one embodiment, the communication of an “instruction” comprises the communication of key management messages and/or a record which contain information (such as “Needs Service” flag(s)) that enables the KVL itself to determine whether it should deliver rekeying messages in either a “black transfer to target” mode or “red transfer to target” mode. In such case, the information communicated by the KMF to the KVL comprises an indirect instruction because, in effect, the KVL derives from the information a directive to deliver rekeying messages in either a “black transfer to target” mode or “red transfer to target” mode. Alternatively, the instruction may comprise a directive issued directly by the KMF (e.g., executable software code) to the KVL. Similarly, the “execution” of an instruction comprises the performing of an action (e.g., delivering rekeying messages in “black transfer to target” or “red transfer to target” mode) according to a direct or indirect instruction as defined herein. In either case, the instruction may be contained within, or may be independent from, the key management message(s) sent from the KMF.

In store and forward mode, the KVL processor 203 operates to store at least a portion of the record and/or instructions received from the KMF at various memory locations in memory 205. For example, as shown in FIG. 2, the record stored in the various memory locations of memory 205 includes the target ID, alias, and key management message(s) associated with the various target units, each of which may be provided to the KVL through the KMF interface 201. The target ID comprises in one embodiment a numeric ID (e.g., serial number) of the various target units. The alias comprises in one embodiment a more “user friendly” identification of the target units, such as “BOB'S RADIO.” The record may further include flags (such as “Needs Service” flags) or indicia of those target units that are designated to receive key management messages in red-transfer to target mode. The key management messages comprise in one embodiment rekeying messages to be delivered to the various target units.

In one embodiment, the key management messages (e.g., rekeying messages), whether they are to be delivered in red transfer to target mode or black transfer to target mode, are communicated to the KVL in encrypted (“black”) format and also stored in the memory in encrypted (“black”) format. For those messages that are to be delivered in red transfer to target mode, the encrypted (“black”) key management messages delivered to the KVL are decrypted by the encryption unit 207, yielding decrypted (“red”) messages to be transferred to the target. The decrypted (“red”) messages are encrypted by the encryption unit 207, yielding encrypted (“black”) messages that are stored in the memory 205. Then, when the KVL is to deliver the messages to a target unit, the processor 203 causes the encrypted (“black”) messages stored in the memory 205 to be decrypted by the encryption unit 207, yielding decrypted (“red”) messages for delivery to the target unit. In one embodiment, for those messages that are to be delivered in black transfer to target mode, the encrypted (“black”) key management messages delivered to the KVL are encrypted a second time by the encryption unit 20, yielding twice encrypted (“black”) messages that are stored in the memory 205. Prior to delivery of the messages, the twice encrypted (“black”) messages are decrypted by the encryption unit 207, yielding the original encrypted (“black”) messages for delivery to the target encryption units.

The memory 205 also includes memory locations for storing response messages (designated “RESPONSE” in FIG. 2) from the various target units, provided through the target interface 209. The response messages may comprise, for example, an indication of successful or unsuccesful attempts to transfer key management messages to the various target units. In one embodiment, the KVL collects the responses and reports them to the KMF, via the KMF interface.

Upon first connecting the KVL to an encryption unit, the KVL performs a handshaking process with the unit to determine its identity and to determine if the unit is a target unit. For convenience, the term “candidate encryption device” will be used to refer to a device whose identity is not yet ascertained, hence that is not yet known to be a target unit. In one embodiment, this is accomplished by the processor 203 first ascertaining the numeric unit ID of the candidate encryption device. The processor 203 compares the identity of the candidate encryption device to the identities of the target encryption devices stored in memory 205. If the identity of the candidate encryption device matches any of the identities of the target units (e.g., unit ID's) stored in memory, the processor 203 determines that the candidate encryption device is a target unit. Conversely, if the identity of the candidate encryption device does not match any of the unit ID's stored in memory, the processor 203 determines that the candidate encryption device is not a target unit.

If the candidate encryption device is determined to be a target unit, the KVL processor 203 retrieves from memory one or more key management messages destined for that target (e.g., twice-encrypted key management messages, in black transfer to target mode or once-encrypted key management messages, in red transfer to target mode), decrypts the messages (e.g., yielding “black” messages in black transfer to target mode or “red” messages in red transfer to target mode) and then causes the messages to be communicated to the target unit. If the candidate encryption device is determined not to be a target unit, the KVL processor 203 does not communicate any key management messages (e.g., rekeying messages) to that unit. The decision of whether to load keys/messages into a particular device, the decision of which keys/messages to load into a particular device and the decision of which security level (Black or Red) to use for the transfer is taken out of the hands of the operator. The processor 203 causes the right keys to be loaded into the right encryption devices, at the right security level automatically upon connection of the KVL to the respective candidate units. Accordingly, it is virtually impossible for a KVL operator in the field to accidentally rekey a device that should not have been rekeyed, to deliver the wrong keys to a particular device or to deliver rekeying messages at the wrong security level.

A display 211 is provided for displaying messages to the KVL operator. It will be appreciated that the display 211 may take various forms to display various different items of information. Display 211 A represents one example of a display that might appear upon first connecting the KVL to one of the target units. The display 211A shows the alias (“BOB's RADIO”) of the target unit and the ID (SN: 25692) of the target unit. A message (“1 OF 5 ”) informs the operator that BOB's RADIO is one of five target units that are to receive key management messages. This latter message helps to ensure that the KVL operator will reach each of the target units. Also shown are instruction fields (“UPDATE” and “CLEAR”) identifying instructions that may be performed by the operator. In one embodiment, the instructions are exercisable by the operator pressing a suitable key (e.g., an “UPDATE” key) on a conventional keypad 213. Alternatively, the instruction fields themselves may comprise touch-responsive “keys,” for example, that are exercisable by the operator touching the desired portion (e.g., “UPDATE”) of the display. In one embodiment, exercise of the “UPDATE” instruction by the operator causes the processor 203 to automatically deliver key management messages to the target unit based on the record stored in the memory 205, as heretofore described.

Display 211B represents one example of a display that might appear after attempting an update of a target unit. The display 211B, like the display 211A, shows the alias (“BOB's RADIO”) of the target unit and the ID (SN: 25692) of the target unit. Upon attempting the update, the KVL processor 203 receives an acknowledgement from the target unit indicating, for example, whether the attempted update was successful or unsuccessful. In one embodiment, the acknowledgement is a message (“RESPONSE”) that is stored in the memory 205 of the KVL. Then, in one embodiment, the processor 203 causes the display 211 to display a message indicative of success or failure of the attempted update. In the example display 211B, a checkmark symbol (“✓”) informs the operator that the update of BOB's RADIO was successfully completed. Of course, a variety of messages or symbols other than a checkmark might be used to inform the operator of the outcome of the attempted update. Optionally, a message indicative of an unsuccessful attempt might also be displayed if the KVL is connected to a candidate unit that is determined not to be a target unit, or if the target unit does not have the appropriate keys to decode the message.

In one embodiment, after all targets have been contacted, the KVL processor 203 uploads detailed acknowledgements collected and stored in the memory 205 to the KMF, via the KMF interface 201. The detailed acknowledgements may include an identification of which keys were delivered to which units, an identification of which keys were unsuccessfully delivered, error conditions, and the like. Hence, the detailed acknowledgements provide an explicit and reliable means for a centralized key management facility to confirm rekeying results. If any of the detailed acknowledgements indicate a failed attempt to deliver key management messages, the KMF may adjust the security level of the transfer from black to red, and re-attempt the transfer, as appropriate.

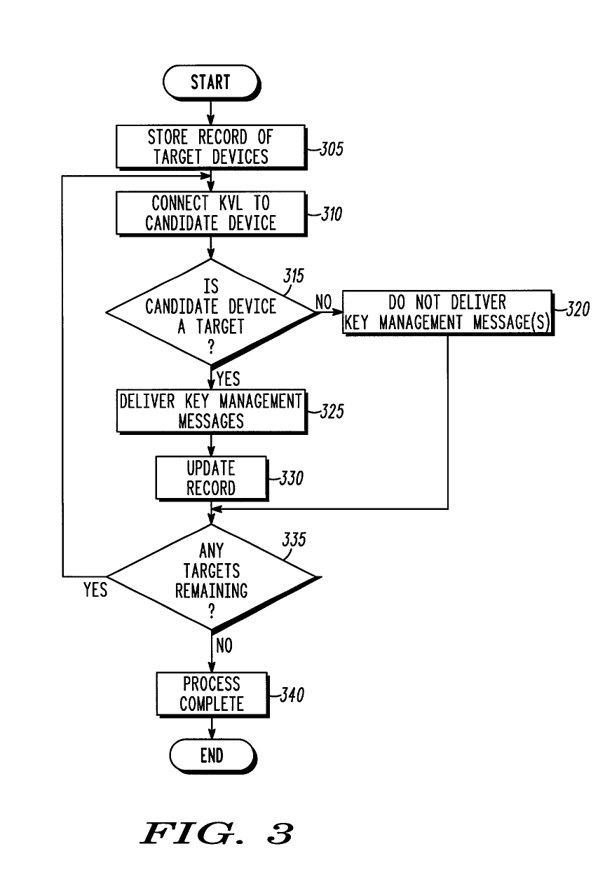

FIG. 3 is a flowchart illustrating a rekeying method according to one embodiment of the invention. At step 305, the key delivery device (e.g., KVL) stores a record of target encryption devices that are to receive one or more key management messages, such as rekeying messages. The record may include identification codes and/or aliases of the target encryption devices and flags or other indicia of the security level that is to be used for transferring the key management messages, as heretofore described. In one embodiment, the record is communicated to the KVL from a Key Management Facility (KMF) remote from the KVL, via one or more KMM frames, as will be described in relation to FIG. 8. Alternatively, the record may be communicated to the KVL separately from the KMM frames. At step 310, the KVL is operably connected (e.g., by cable or wireless connection) to a candidate encryption device. At step 315, the KVL determines if the candidate encryption device is a target encryption device. In one embodiment, this is accomplished by the KVL first determining an identity (e.g., numeric unit ID) of the candidate device, then comparing the unit ID of the candidate device to the unit IDs of the target devices stored in the record. The KVL determines the candidate encryption device to be a target encryption device if the unit ID of the candidate encryption device matches a unit ID of a target encryption device identified in the record. Conversely, the KVL determines the candidate encryption device not to be a target encryption device if the unit ID of the candidate encryption device does not match a unit ID of a target encryption device identified in the record.

If at step 315 the candidate device is determined by the KVL to be a target device, the KVL delivers key management messages to the unit (step 325). The KVL may deliver encrypted (“black”) or decrypted (“red”) rekeying messages to the candidate device, now determined to be a target device, based on flags (e.g., “Needs Service” flags) or other indicia of the appropriate security level, as heretofore described. The target device may receive one or more messages, and each message may include one or more rekeying messages. Also, the message(s) delivered to the target device may differ from the message(s) delivered, or yet to be delivered, to other target devices. At step 330, the KVL updates the record, for example, to reflect that the target device has been successfully or unsuccessfully rekeyed.

Then, the process proceeds to step 335 where the KVL determines if there are any target devices remaining that are to receive key management messages. If there are no target devices remaining, the process is complete (step 340). Otherwise, if there are still target devices remaining, the process returns to step 310 where the KVL is connected to a next candidate device, and so forth. Optionally, if there are still target devices remaining, a message is displayed to the operator indicating how many or which ones of the target devices are remaining.

If at step 315 the candidate device is determined by the KVL not to be a target device, the KVL does not deliver any key management messages to the unit (step 320). For example, if a delivery is attempted by an operator to a candidate device determined not to be a target device, the KVL will block such attempt at step 320. Then, the process continues to step 335 where the KVL determines if there any target devices remaining, as heretofore described.

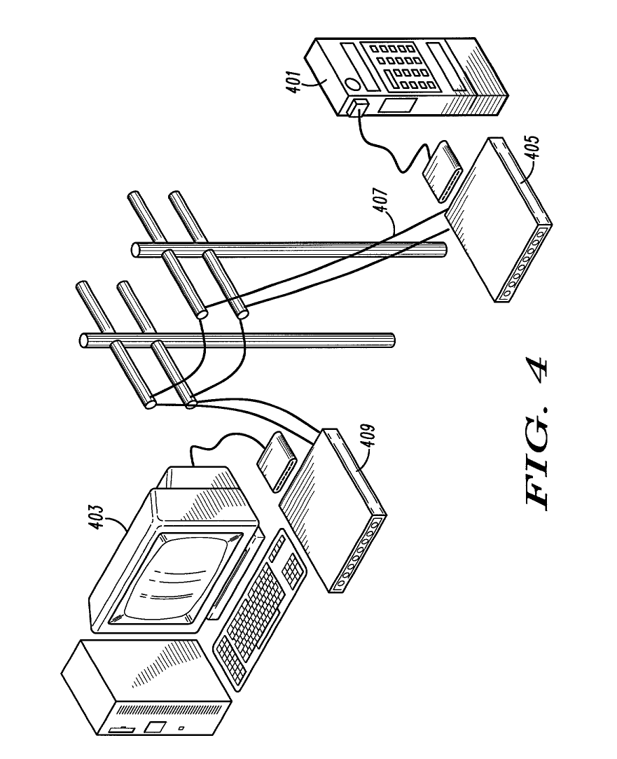

FIG. 4 illustrates a key delivery device 401 (e.g., KVL) connected to a key management facility (KMF) 403. In one embodiment, the KVL operator initiates a transfer of key management messages by entering the proper commands into the KVL 401, which in turn accesses the KMF through modem 405, standard telephone lines 407 and the modem 409 attached to the KMF. Key management messages, such as the record of target units, rekeying messages and instructions is passed from the KMF 403 to the KVL 401 through modem 409, telephone lines 407 and modem 405. The KVL 401 is then usable to transfer key management messages to various encryption units, as heretofore described. In a preferred embodiment, all key management messages passed between the KMF 403 and the KVL 401 are encrypted for security reasons. It will be appreciated the KVL 401 may be connected directly to the KMF 403 with a null modem if in close proximity. The null modem replaces the first modem 409, the telephone lines 407 and the second modem 405 from FIG. 4.

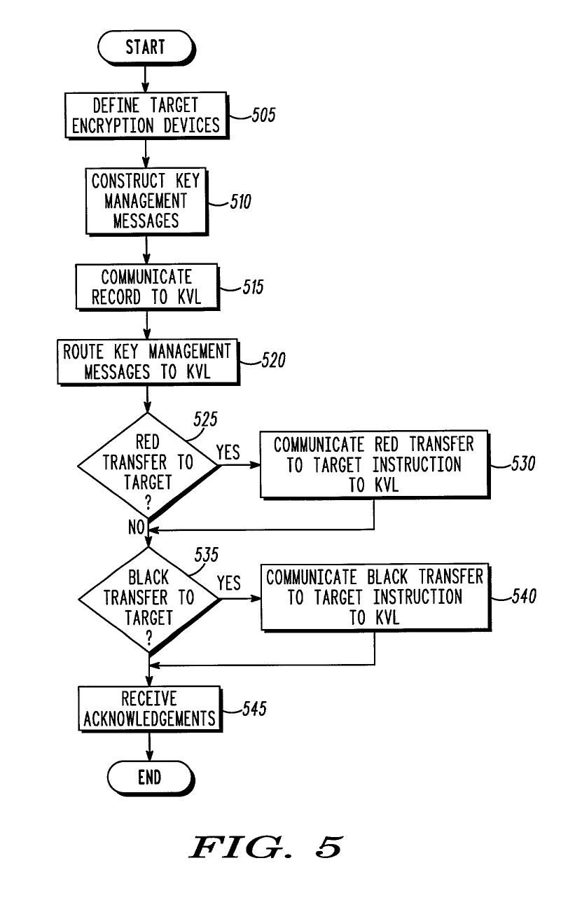

FIG. 5 is a flowchart illustrating steps of a rekeying method performable by a key management facility (KMF) of the type shown in FIG. 4 according to one embodiment of the invention. At step 505, the KMF determines one or more encryption devices that are targeted to receive key management messages, thereby defining target encryption devices. At step 510, the KMF constructs one or more key management messages for each of the target encryption devices. In one embodiment, the key management messages are encrypted at the KMF, defining encrypted (“black”) key management messages.

At step 515, the KMF communicates a record to the KVL identifying the target encryption devices and identifying which ones of the key management messages are to be delivered to which ones of the target encryption devices. At step 520, the KMF routes the key management messages to the key delivery device. The record and key management messages may thereafter be stored in memory of the key delivery device. As will be appreciated, the “record” is a functional term that may be implemented in alternative ways. In the preferred embodiment, the record is inherent in the key management messages themselves. That is, the communication of a “record” comprises the communication of key management message frames, including key management messages from the KMF to the key delivery device. The key management message frames will be described in greater detail in relation to FIG. 8. In such embodiment, the key management message frames are used by the key delivery device to identify the target encryption devices, to identify which ones of the key management messages are to be delivered to which ones of the target encryption devices, and to identify the security level with which key management messages are to be delivered from the KVL to the target devices. Alternatively, a record may be delivered separately from the key management message frames. In one embodiment, the KMM frames and/or record are sent in encrypted (“black”) format from the KMF to the key delivery device.

In the preferred embodiment, the record further includes some indicia of the security level with which key management messages are to be delivered from the KVL to the target devices. At step 525, the KMF determines if any of the messages are to be delivered in red store and forward mode. If so, the KMF communicates a red transfer to target instruction or otherwise flags those messages that are to be delivered in red store and forward mode with some indicia of the red store and forward mode at step 530. The KMF constructs, modifies or appends the record, as the case may be, to identify those devices that are so flagged for red store and forward mode.

At step 535, the KMF determines if any of the messages are to be delivered in black transfer to target mode. If so, the KMF communicates a black transfer to target instruction or otherwise flags those messages that are to be delivered in black store and forward mode with some indicia of the black store and forward mode at step 540. Generally, any messages that are not flagged for red store and forward mode will be delivered in black transfer to target mode. This may be accomplished via OTAR or via black store and forward mode. In one embodiment, the messages that are to be delivered in black transfer to target mode are not flagged. Optionally, the messages might also be flagged to distinguish between those messages that are to be delivered via OTAR and those that are to be delivered by black store and forward mode.

At step 545, the KMF receives detailed acknowledgements from the key delivery device and determines, based on the detailed acknowledgements, whether the message transfer(s) were successful or unsuccessful. The detailed acknowledgements include information collected by the key delivery device after attempting to deliver key management messages to one or more target encryption devices. In one embodiment, the target encryption devices communicate messages to the key delivery device indicative of outcomes of success or failure of attempted delivery of the key management messages to the target devices, and the key delivery device provides detailed acknowledgements to the KMF reporting at least a portion of the respective messages collected from the target encryption devices. Based on the detailed acknowledgements, the KMF may re-attempt to send certain messages. For example, for those messages that were not successfully transferred in black transfer to target mode, the KMF may set a Red flag so that the next attempt will be accomplished in red transfer to target mode.

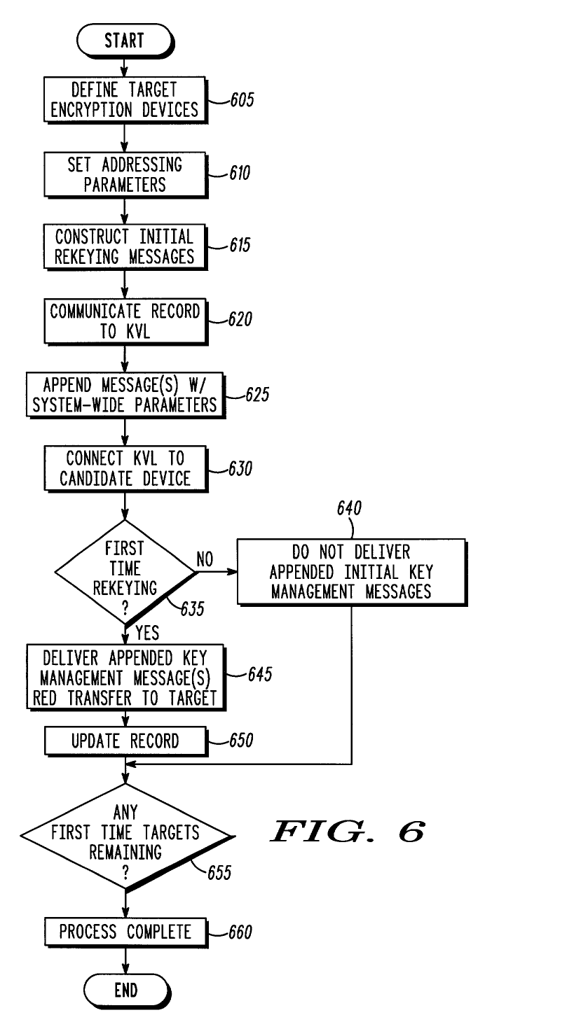

FIG. 6 is a flowchart identifying steps for initial configuration of a centralized key management system according to one embodiment of the invention. At step 605, the KMF defines one or more target encryption devices that are to receive initial key management messages (e.g., first-time rekeying messages). At step 610, the KMF sets addressing parameters for the initial key management messages. In one embodiment, the addressing parameters include a default destination ID of the encryption devices targeted to receive the initial key management messages. The default destination ID is derived in one embodiment from the respective target devices' Data System ID, presumed to be an existing, readily available ID that has been established between each encryption unit and the data system infrastructure in order to enable general data services for the unit. The Data System ID is used, for example, in ASTRO™ over-the-air-rekeying (OTAR) systems, available from Motorola.

At step 615, the KMF constructs one or more initial key management messages (e.g., initial rekeying messages) for the target encryption devices. In one embodiment, the initial key management messages include a source ID of the KMF and a destination ID equal to the default destination ID of the respective target units. In one embodiment, the initial key management messages are encrypted at the KMF, defining encrypted (“black”) key management messages, and are accompanied with a Red flag or red transfer to target instruction.

At step 620, the KMF communicates a record to the KVL (e.g., by telephone line 407) with the initial key management messages. In a preferred embodiment, the record identifies the target encryption devices, the addressing parameters associated with the target devices, identifies which ones of the initial key management messages are to be delivered to which ones of the target encryption devices and also the security level to be used for the delivery. The record and key management messages may thereafter be stored in memory of the KVL. In a preferred embodiment, the KVL appends the initial key management messages with system-wide parameters at step 625, defining appended messages that may be stored in the memory of the KVL. The system-wide parameters may comprise, for example, programming messages to the encryption unit establishing the KMF's ID as the valid source ID for rekeying messages and/or establishing message number counters. The system-wide parameters in one embodiment are constructed at the KVL. Alternatively, the system-wide parameters may be constructed at the KMF and forwarded to the KVL along with the key management messages and/or record.

At step 630, the KVL is operably connected (e.g., by cable or wireless connection) to a candidate encryption device. At step 635, the KVL determines if the candidate encryption device is a target encryption device, i.e., that is to receive an initial key management message. In one embodiment, this is accomplished by the KVL first determining an identity (e.g., numeric unit ID) of the candidate device, then comparing the unit ID of the candidate device to the default unit IDs of the target devices stored in the record. The KVL determines the candidate encryption device to be a target encryption device if the unit ID of the candidate encryption device matches a default unit ID of a target encryption device identified in the record. Conversely, the KVL determines the candidate encryption device not to be a target encryption device if the unit ID of the candidate encryption device does not match a default unit ID of a target encryption device identified in the record.

If at step 635 the candidate device is determined by the KVL to be a target device, the KVL delivers the appended initial key management messages (i.e., including initial key management messages and system-wide parameters) to the unit (step 645). In one embodiment, the initial key management messages are accompanied with a red flag or transfer to target instruction causing the KVL to decrypt the messages and to deliver decrypted (“red”) key management messages to the designated target. The red transfer to target instruction may comprise a direct or indirect instruction as described in relation to FIG. 2. The target device may receive one or more initial key management messages, and each message may include one or more rekeying messages. Also, the initial key management message(s) delivered to the target device may differ from the initial key management message(s) delivered, or yet to be delivered, to other target devices.

At step 650, the KVL collects information from the target devices, for example, relating to success or failure of attempted delivery of key management messages to the target devices and updates the record, for example, to reflect that the target device has been successfully or unsuccessfully rekeyed. Optionally, the KVL may forward the information collected from the target devices, or a portion thereof, to the KMF in the form of detailed acknowledgements, as described in relation to FIG. 5 (step 545).

At step 655, the KVL determines if there are any target devices remaining that are to receive initial key management messages. If there are no target devices remaining, the process is complete (step 660). Otherwise, if there are still target devices remaining, the process returns to step 630 where the KVL is connected to a next candidate device, and so forth. Optionally, if there are still target devices remaining, a message is displayed to the operator indicating how many or which ones of the target devices are remaining. In one embodiment, after the delivery of first time key management messages is complete, any future key management messages are constructed at the KMF and delivered to the KVL, as described in relation to FIG. 5, and delivered from the KVL to the target devices as described in relation to FIG. 3.

If at step 635 the candidate device is determined by the KVL not to be a device targeted to receive initial key management messages, the KVL does not deliver appended initial key management messages to the unit (step 640). For example, if a delivery of first-time rekeying messages is attempted by an operator to a candidate device determined not to be a target device, the KVL will block such attempt at step 640. Then, the process continues to step 655 where the KVL determines if there any target devices remaining, as heretofore described.

In accordance with one aspect of the present invention, there is provided a protocol for the formation and exchange of messages, including key management messages and other proprietary related data items between a KVL and a target communication device, usable in the above-described store-and-forward rekeying system, or in a manual or OTAR rekeying system. The protocol is referred to herein as “the KVL APCO Interface Protocol” or simply “the protocol.” The term “target communication device” hereinafter refers broadly to any device that may communicate with a KVL and includes, but is not limited to, mobile or portable encryption units (e.g., radios), a KMF, another KVL, Digital Interface Unit (DIU), Radio Network Controller (RNC), or Encryption Management Controller (EMC).

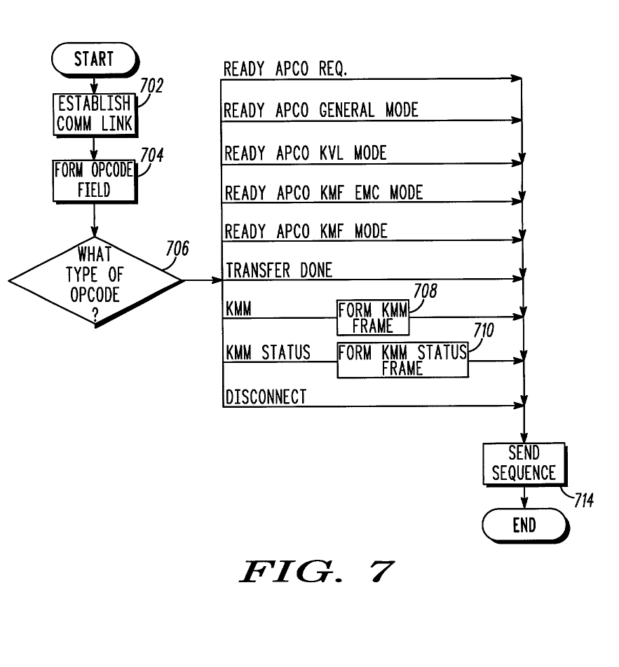

A flowchart illustrating general steps of the protocol is shown at FIG. 7. The process begins at step 702 with the KVL establishing a communication link with the target. Methods of establishing communication links between KVLs and target communication units are well known in the art. In one embodiment, a physical link is established between the KVL and the target. Where the target is a KMF, the physical link comprises a full duplex RS232 line. Otherwise, the physical interface between the KVL and most targets comprises a bi-directional (half duplex) communications line used to transfer data to or from a target device at 4 Kbps.

Once a communication link has been established, the KVL can send a series of operation-codes “opcodes” to the target to accomplish a desired task. The opcode(s) form a part of a one-byte operation-code field “opcode field,” formed at step 704. The opcode(s) and/or opcode field(s) may be formed by the KVL or the target. In the KVL APCO Interface Protocol, a byte consists of a single start bit (“SB”) transmitted for 250 μs, followed by eight data bits (“D7,” “D6,” “D5,” “D4,” “D3,” “D2,” “D1” and “D0”) at 250 μs per bit, and a single parity bit (“PB”) (even parity) for 250 μs.

A list of opcodes and opcode fields according to one embodiment of the invention is provided in Table 1 below:

TABLE 1

| OPCODES | USAGE |
|---|---|
| Ready ASN [$90] | Not used with the KVL-APCO Interface |
| Ready Astro [$9C] | Protocol. Used for backwards |
| | compatibility with ASN keyloading |
| | protocol on the KVL-EMC interface. |
| | Note: This opcode is never used on the |
| | KVL-KMF or KVL-KVL interfaces. |
| Ready APCO Req | Used by the KVL to request if a connected target |
| [$C0] | speaks. KVL-APCO Interface Protocol. |
| Ready APCO | Sent in response to a Ready APCO Req |
| General Mode | and indicates the target speaks KVL-APCO |
| [$D0] | Interface Protocol and is operating in a |
| | general environment or mode. |
| | Note: For release 3.0A, encryption devices |
| | operating in DIUs, RNCs, and subscribers |
| | should reply with this opcode. |
| Ready APCO | Sent in response to a Ready APCO Req |
| KVL Mode | and indicates the target speaks KVL-APCO |
| [$D1] | Interface Protocol and is operating in a |
| | KVL environment or mode. |
| | Note: For release 3.0A, encryption devices |
| | operating in a KVL should reply with this |
| | opcode. |
| Ready APCO | Sent in response to a Ready APCO Req and |
| KMF EMC Mode | indicates the target speaks KVL-APCO Interface |
| [$D2] | Protocol and is operating in a KMF environment or |
| | mode. |
| | Note: For release 3.0A, encryption devices |
| | operating in a KMF should reply with this opcode. |
| Ready APCO KMF | Sent in response to a Ready APCO Req |
| [$D3] | and indicates the target speaks KVL-APCO |
| | Interface Protocol and is the KMF. |
| | Note: For release 3.0A, the KMF should |
| | reply with this opcode. |
| Transfer Done | Indicates that a KVL or Target has |
| [$C1] | transferred all queued KMMs. |
| KMM | Indicates the subsequent octets are a KMM |
| [$C2] | frame containing KMM(s). |
| KMM Status | Indicates the subsequent octet contains the |
| [$C3] | pass/fail status of the last received KMM. |
| CTO Data | Indicates that 16 Bytes if CTO test data |
| [$96] | will follow. |
| Disconnect | Indicates the transfer is complete and is |
| [$92] | being terminated. |

The READY ASN and READY ASTRO opcodes are not used with the KVL APCO Interface protocol but are provided for backwards compatibility with ASN and ASTRO keyloading protocols. Thus, for example, if one of these opcodes is detected while a KVL is attempting to establish a communications link with a target, then the KVL is operating in an ASN mode or ASTRO mode.

The READY APCO REQ opcode is used by the KVL to request if a target recognizes (“speaks”) the KVL APCO Interface Protocol. The target will respond with either the READY APCO GENERAL MODE, READY APCO KVL MODE, READY APCO KMF EMC MODE or READY APCO KMF MODE opcode. Generally, these latter opcodes identify that the target speaks the KVL APCO Interface Protocol and also identifies the particular mode characteristic of the target. For example, the READY APCO GENERAL MODE indicates that the target is operating in a general environment or mode. In one embodiment, target devices comprising DIUs, RNCs, and subscriber radios reply with the READY APCO GENERAL MODE. The READY APCO KVL MODE indicates that the target is operating in a KVL environment or mode, and should thereby be used by encryption devices operating in a KVL. The READY APCO KMF EMC MODE indicates that the target is operating in a KMF environment or mode. Encryption devices operating in a KMF should reply with this opcode. The READY APCO KMF MODE indicates that the target is the KMF itself, and should thereby be used by the KMF.

The TRANSFER DONE opcode indicates that a KVL (or target) has transferred all queued key management messages that it desires to exchange with the target (or KVL). The DISCONNECT opcode is used to indicate that the keyload session is complete and the KVL is disconnecting from the target.

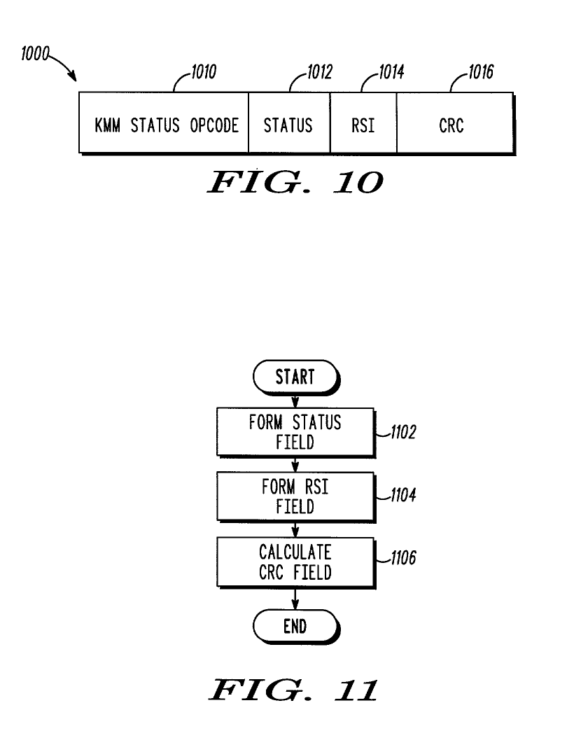

The KMM opcode indicates that a KVL (or target) will be sending a key management message (KMM) frame immediately following the KMM opcode. The KMM frame has a specific format that will be described in detail in relation to FIG. 8. Similarly, the KMM STATUS opcode indicates that a KVL (or target) will be sending a key management message status frame (KMM status) frame immediately following the KMM STATUS opcode. The KMM status frame is used to transfer the pass/fail status of the last received KMM. The KMM status frame has a specific format that will be described in detail in relation to FIG. 10.

Thus, depending on the type of opcode (step 706), additional data may or may not follow the opcode field. The opcodes READY APCO REQ, READY APCO GENERAL MODE, READY APCO KVL MODE, READY APCO KMF EMC MODE, READY APCO KMF MODE, TRANSFER DONE, and DISCONNECT are stand-alone opcodes. That is, at step 714, they are sent from the KVL to the target (or from the target to the KVL) without any additional data. The opcodes KMM and KMM STATUS indicate that additional data frames will follow. The data frames KMM and KMM STATUS associated with the respective opcodes KMM and KMM STATUS are formed at steps 708 and 710, respectively. In either case, these data frames may be formed by the KVL itself (e.g., in a manual rekeying system), by the KMF and then forwarded to the KVL (e.g., in a store-and-forward operation) or by the target. If more messages are to follow, other opcodes are formed at step 704 and, if appropriate, other data frames are formed at step 708, 710 and so forth until all desired messages are exchanged between the KVL and the target.

FIG. 8 is a bit field representation of a KMM frame 800 formed according to the KVL APCO Interface Protocol. Generally, the KMM frame format of FIG. 8 allows for the transfer of variable length KMMs, allows for encryption of the KMM(s), and allows for routing of KMMs through the KVL to a target device in a store-and-forward operation. The KMM frame comprises, in sequence, the KMM opcode 820, a length field 822, a control field 824, a target destination (“DEST RSI”) field 826, an optional encryption data field (“Esync”) 828, a KMM field 830 and a CRC field 832. The Esync field 828, if any, and the KMM field 830 are defined as the “body” of the KMM Frame. The KMM frame and any of its associated fields may be formed by the KVL itself (e.g., in a manual rekeying system), by the KMF and then forwarded to the KVL (e.g., in a store-and-forward operation), or by the target.

The process of forming the KMM frame 800 (step 708, FIG. 7) will be described in greater detail with reference to FIG. 9. It should be noted that the process of FIG. 9 is undertaken after the KMM opcode has already been formed at step 704, FIG. 7. At step 902, a variable length KMM field 830 is formed. It is expected that normally there will only be one KMM in the KMM field 830. However, the KMM field 830 may contain multiple KMMs. Generally, the KMM field 830 may contain KMM(s) in standard APCO defined format (in which case the APCO Compliant bit in Control frame 424 is set) or may contain proprietary KMM(s). The particular format of APCO KMM(s) or proprietary KMM(s) will not be described in detail herein. Suffice it to say that the KMM(s) may include a source and/or destination RSI field, a Message Number Period, a status frame, and/or a record including target units and messages that are to be delivered to the target units (see FIG. 2).

If outer-layer encryption is used (step 904), a 13-byte encryption data field (“Esync” block 828) is formed at step 906. The Esync block 828 contains the information needed to decrypt the KMM(s) contained in the KMM frame 830. It includes a 9-byte Message Indicator, 1-byte algorithm ID, 2-byte key ID and 1-byte secondary SAP. The KMM field 830 and Esync block 828 (if any) forms the Body of the KMM frame 800.

A two-byte length field 822 is formed at step 908. The length field 822 identifies the length of the KMM Frame, including the Control, Dest RSI, Body and CRC fields. A one-byte control field 824 is formed at step 910. The control field 824 contains a collection of control bits, including an APCO FORMAT COMPLIANT bit, VALIDATE bit, ENCRYPTION bit and a STATUS bit. The various control bits are shown and described in Table 2 below.

TABLE 2

| Control Bit | Usage |
|---|---|
| b0:AC: | Indicates the KMM fully complies with the |
| APCO Format | APCO OTAR standard and should be |
| Compliant | processed the same as if received over the |
| KMM | air. |
| b1:ENC: | Indicates outer layer encryption is used on |
| Encryption | the KMM(s) and the receipt of an esync |
| | block should be expected. |
| b2:VAL: | Indicates whether APCO validation rules |
| Validate | are required. |
| b3:STS | If the contained KMM is a response KMM, |
| Fail Status | this bit indicates what type of response it is. |
| | A 0 indicates the response is a Success |
| | response. A 1 indicates the response is a |
| | Fail response. If the contained KMM is not |
| | a response KMM, this bit should be set to 0. |
| | Note: With Store and Forward operation, |
| | the KVL must provide the KVL operator |
| | with immediate feedback on the success or |
| | failure of the keyload session. Since the |
| | KVL cannot view the contained response |
| | directly, as it is encrypted with one of the |
| | targets TEKs, this bit is used for that |
| | purpose. |
| b4:Reserved | N/A |
| b5:Reserved | N/A |
| b6:Reserved | N/A |
| b7:Reserved | N/A |

When bit 0 (i.e., the APCO FORMAT COMPLIANT bit) in the control byte is set, this indicates that the KMM 830 contained in the Frame 800 is fully compliant with the message formats defined by the APCO 25 OTAR standard. In one embodiment, the APCO COMPLIANT bit is equivalent to the manufacturers ID field for OTAR data packets. Thus, the KMM may be processed in generally the same manner as if it were received over the air, regardless of whether an OTAR, manual or store-and-forward system is being used. When bit 1 (i.e., the ENCRYPTION bit) is set, this indicates that encryption is being used and the body of the KMM frame 800 contains an esync block. When bit 2 (i.e., the VALIDATE bit) is set, this indicates that full validation of KMM header fields is required by the receiver. When bit 3 (i.e., the STATUS bit) is set to 1, this indicates that the contained KMM is a Response and the status is FAIL. When the STATUS bit is 0, the contained KMM is either a Success Response or the KMM is not a response.

A three-byte target destination (“DEST RSI”) field 826 is formed at step 912. The DEST RSI field 826 allows for both encrypted (“black transfer to target”) and unencrypted (“red transfer to target”) KMMs to be delivered in a store-and-forward mode of operation. As previously described, the store-and-forward mode of operation involves sending a KMM frame from a KMF to a KVL, the KMM frame including a key management message KMM that is stored in the KVL and ultimately forwarded to a target encryption unit (“radio”).

In a black store and forward operation, the DEST RSI field 826 in the KMM Frame header will be the same as the Destination RSI field in the KMM itself (i.e., the RSI of the target). The KVL determines the target from the DEST RSI field 826, because the KMM itself is encrypted in black store and forward mode.

In a red store and forward operation, the DEST RSI field 826 in the KMM Frame header will differ from the Destination RSI field in the KMM itself. The DEST RSI field 826 will identify the present target (e.g., the KVL), whereas the Destination RSI field in the KMM itself identifies the final target (e.g., a target radio) of the KMM. The KMM (and its Destination RSI field) are decrypted by the KVL, thus the KVL uses it to determine the final destination for the KMM.

As noted with respect to FIG. 2, the KMMs in both the red and black transfer to target modes of operation are communicated to the KVL in encrypted (“black”) format. In a black store-and-forward operation, the KVL encrypts the encrypted (“black”) KMM frame a second time, yielding twice encrypted (“black”) messages that are stored in its memory. Prior to delivery of the KMMs to the target, the twice encrypted (“black”) KMMs are decrypted, yielding the original encrypted (“black”) KMMs for delivery to the target encryption units. In a red store-and-forward operation, the encrypted (“black”) key management messages delivered to the KVL are decrypted by the encryption unit 207, yielding decrypted (“red”) messages to be transferred to the target. The KVL constructs a new KMM Frame header 800, with the DEST RSI field 826 set to the RSI specified in the KMM. Then, in a second leg of the store-and-forward operation, the KVL delivers the unencrypted (“red”) KMM frame to the RSI specified in the DEST RSI field 826 of the newly constructed KMM Frame header 800.

Whenever the DEST RSI field 826 in the KMM Frame header 800 is the same as the Destination RSI field in the KMM itself, this indicates that the receiving unit is the final target for the KMM. In the second leg of the above red store-and-forward scenario, for example, the newly constructed KMM Frame header has a DEST RSI field 826 that matches the Destination RSI field in the KMM itself, thus indicating that the RSI in the DEST RSI field 826 is the final target for the KMM. It should also be noted that the KVL itself might also be the final target for the KMM, in which case the KMM Frame header is not reconstructed at the KVL. The DEST RSI field 826 in the original KMM Frame header and the Destination RSI field in the KMM would both specify the RSI of the KVL. The KVL will process the KMM and may store keys, erase keys, etc. depending on the KMM received.

Finally, a two-byte CRC (“cyclic redundancy check”) field 832 is formed at step 914. The CRC field 832 is calculated over the Control Field 824, Dest RSI Field 826, and Body (Esync 828 and KMM 830) fields.

Now turning to FIG. 10, there is shown a bit field representation of a KMM STATUS frame 1000 formed according to the KVL APCO Interface Protocol. Generally, the KMM STATUS frame 1000 is used to transfer the pass/fail status of the last received KMM. The KMM STATUS frame comprises, in sequence, the KMM STATUS opcode 1010, a status field 1012, an RSI field 1014 and a CRC field 1016. The KMM STATUS frame is formed by the entity receiving the last KMM, which may comprise the KVL, mobile or portable radio, etc.

The process of forming the KMM STATUS frame 1000 (step 710, FIG. 7) will be described in greater detail with reference to FIG. 11. The process of FIG. 11 is undertaken after the KMM STATUS opcode has already been formed at step 704, FIG. 7. The process begins at step 1102 with the formation of a one-byte status field 1012. A three-byte RSI field 1014 is formed at step 1104 that identifies the unit sending the KMM STATUS message. A two-byte CRC field 1016 is calculated at step 1106. The CRC field 1016 is calculated over the Status and RSI fields using the same CRC calculator as for the KMM opcodes. The status field 1012 contains one of various status values shown and described in Table 3 below.

TABLE 3

| Status | Value(Hex) |
|---|---|
| Success | $00 |
| Fail for unspecified reason | $01 |
| Reserved for future use | $02 thru $04 |
| Out of Memory | $05 |
| Outer Layer Unable to | $06 |
| Decrypt | |
| Reserved for future use | $07 thru $FE |
| MAC Error for “RED” | $FE |
| SAF | |
| Inner Layer Unable to | $FF |
| Decrypt | |

The KMM STATUS opcode should only be sent if the target determines a KMM Response is not required. For example, if a target can't outer-layer decrypt a KMM message, it would send a KMM STATUS in response. If a KMM response is sent, then the pass/fail bit in the control byte of the KMM frame is used to indicate KMM status. The Out of Memory status will be used by the KVL to indicate to the KMF that the KVL has no more memory available for store-and-forward operation and the received KMM has been discarded. The Fail for Unspecified Reasons status is used to indicate a failure when any of the other status values do not apply. The Outer Layer Unable to Decrypt status is used to indicate a problem with outer-layer decryption has prevented successful processing of the KMM. The MAC Error for RED SAF status is used to indicate the Message Authentication Code for a KMM used in red transfer to target mode has failed. The Inner Layer Unable to Decrypt status is used to indicate a problem with inner layer decryption of a KMM used in red transfer to target mode.

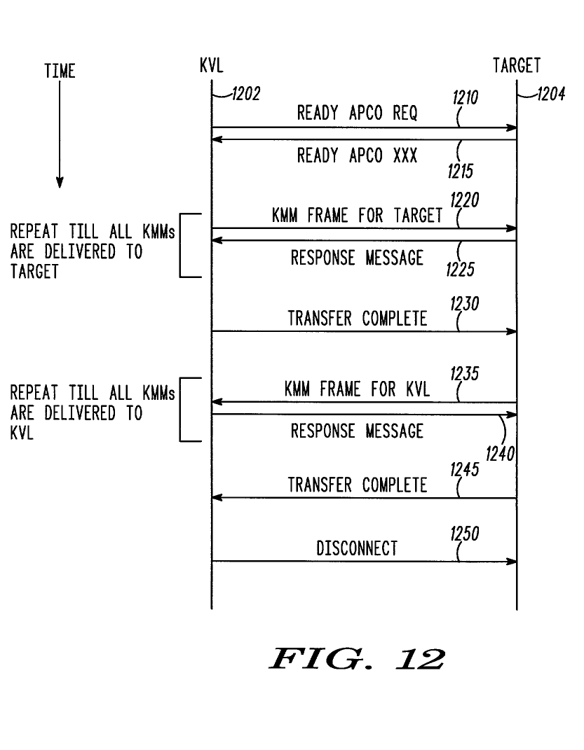

FIG. 12 shows an example message exchange sequence between a KVL and a target according to one embodiment of the present invention. Reference line 1202 indicates messages initiated at the KVL and reference line 1204 indicates messages initiated at the target. Prior to the message exchange, it is assumed that a connection has been made between the KVL and target (step 702, FIG. 7). In the example shown, the KVL first sends a READY APCO REQ message 1210 to the target. In one embodiment, this involves sending a READY APCO REQ opcode, as described in relation to FIG. 7. The READY APCO REQ opcode, in effect, is a request that the target identify whether it speaks the KVL APCO Interface Protocol and, if so, to identify what type of target it is. Assuming the target speaks the KVL APCO Interface Protocol, it responds with an appropriate READY APCO XXX opcode 1215. For example, in one embodiment, targets comprising DIUs, RNCs, and subscriber radios reply with the READY APCO GENERAL MODE opcode, targets operating in a KVL environment or mode respond with a READY APCO KVL MODE opcode, targets operating in a KMF environment or mode respond with a READY APCO KMF EMC MODE indicates that the target is operating in a KMF environment or mode. If the target is the KMF itself, it will respond with the READY APCO KMF MODE opcode.

If no response or the wrong response is received, the KVL will timeout and terminate the connection. Otherwise, the exchange will proceed with the KVL sending KMM(s) 1220 to the target. Multiple KMM(s) 1220 may be queued for the target. The KVL may transfer the KMM frames one at a time, or all at the same time. The target sends appropriate response message(s) 1225 in return. The target might respond with its own KMM frame(s), and/or KMM STATUS frame(s), as appropriate, after any or all of the KMM(s) 1220. For example, if the KVL sent a KMM frame containing a Modify Key command, the target might respond with its own KMM containing a Rekey ACK message 1225. In one embodiment, the KMM STATUS frame is used when an appropriate acknowledgement KMM does not exist. After the KVL transfers all the KMMs it has for the target, it sends a TRANSFER COMPLETE frame 1230 to indicate it has no more KMMs for the target.

If the target has any KMM(s) for the KVL, it sends KMM frame(s) 1235 and the KVL sends appropriate response(s) 1240 (e.g., KMM frame(s) and/or KMM STATUS frame(s)) in return. Generally, the KMF is the only target that will have KMM(s) to send to the KVL. It will be appreciated, however, that any target may send KMM(s) to the KVL according to the present invention. When the target has finished transferring all the KMMs it has for the KVL, it sends a TRANSFER COMPLETE frame 1245 to indicate it has no more KMMs for the KVL. Then, the KVL sends a DISCONNECT frame 1250 to indicate the exchange is complete.

The present disclosure therefore has identified a key management system and communication protocol, usable either in an ongoing manual rekeying scheme or upon initial set-up or fault recovery of a centralized key management system, that reduces the burdens placed upon the key delivery device operator in performing rekeying activity. The system and protocol prevent the operator from accidentally rekeying a particular encryption device that should not have been rekeyed, prevent the operator from loading the wrong keys into a particular encryption device and provide for automatically recording the success or failure of rekeying activity. The system and protocol will support both encrypted (“black transfer to target”) and unencrypted (“red transfer to target”) modes of delivering rekeying messages, provides for adjusting the security level from black transfer to target (via OTAR, or black store and forward) to red store and forward, where appropriate, to update devices that are unable to process key management messages sent in black transfer to target mode, and will support setting up a centralized key management system without manually programming source and destination ID's into the various encryption units.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
forming a key management message operation-code field;
forming a length field;
forming a control field;
forming a target destination field including a target destination identifier;
forming a key management message field;
forming a CRC field;
forming a key management message frame including, in sequence, the operation-code field, length field, control field, target destination field, key management message field, and CRC field; and
receiving, by a key delivery device, the key management message frame.

2. The method of claim 1, further comprising
forwarding, by the key delivery device, the key management message frame to a target communication device identified in the target destination field.

3. The method of claim 1 wherein the key delivery device comprises a key variable loader.

4. The method of claim 1 wherein the target communication device comprises one of a mobile radio, portable radio, digital interface unit, encryption management controller, and radio network controller.

5. The method of claim 1 wherein the step of forming a key management message frame is accomplished by a key management facility, the method including the step of sending the key management message frame from the key management facility to the key delivery device.

6. The method of claim 1 wherein the key management message field is a variable length field.

7. The method of claim 1, wherein the target destination field of the key management message frame includes a first target destination ID associated with a key delivery device, and wherein the key management message field of the key management message frame includes a second target destination ID, the method comprising:
sending the key management message frame to the key delivery device;
determining, by the key delivery device, a target communication device associated with the second target destination ID.

8. The method of claim 7 wherein the key management message field includes an encrypted key management message including the second target destination ID, the step of determining a target communication device comprising:
decrypting the encrypted key management message, yielding a decrypted key management message; and
determining the target communication device identified in the decrypted key management message.

9. The method of claim 8, wherein the target communication device identified in the decrypted key management message differs from the key delivery device, the method further comprising the step of forwarding the decrypted key management message from the key delivery device to the target communication device identified in the decrypted key management message.

10. A method comprising the steps of:
forming a key management status message operation-code field;
forming a status field;
forming an RSI field;
forming a CRC field;
forming a key management status message frame including the key management message status operation-code field, the status field, the RSI field and the CRC field; and
receiving the key management status message frame by one of a key delivery device and a target communication device.

11. A method of exchanging messages between a key delivery device and a target communication device according to a protocol using a number of predefined operation-codes, the method comprising the steps of:
(a) sending, from the key delivery device to the target communication device, a first operation-code requesting the target identify whether it recognizes the protocol;
(b) sending, from the target communication device to the key delivery device, a second operation-code identifying if the target recognizes the protocol; and
(c) sending, from the key delivery device to the target communication device, a key management message frame including
a key management message operation-code field;
a length field;
a control field;
a target destination field including a target destination identifier;
a key management message field; and
a CRC field; and
(d) sending, from the target communication device to the key delivery device, a fourth operation-code responsive to the key management message frame.

12. In a communication system including a key delivery device and a number of encryption devices, a method comprising the steps of:
receiving, by the key delivery device, one or more key management messages including indicia of respective target communication devices that are to receive the key management messages;
operably connecting the key delivery device to one or more candidate encryption devices;
determining, by the key delivery device upon connecting to the one or more candidate encryption devices, which ones of the candidate encryption devices are target encryption devices; and
delivering, from the key delivery device, one or more key management messages to the candidate encryption devices determined by the key delivery device to be target encryption devices.

13. The method of claim 12 further comprising the steps of:
determining, by the key delivery device upon connecting to the one or more candidate encryption devices, which ones of the candidate encryption devices are not target encryption devices; and
not delivering key management messages to the candidate encryption devices determined by the key delivery device not to be target encryption devices.

14. The method of claim 12 further comprising the step of displaying, by the key delivery device upon a successful delivery of a key management message to a target encryption device, a message indicative of the successful delivery of the key management message to the target encryption device.

15. The method of claim 12 further comprising the step of displaying, by the key delivery device upon an unsuccessful delivery of a key management message to a target encryption device, a message indicative of the unsuccessful delivery of a key management message to the target encryption device.

16. The method of claim 12, wherein the step of receiving one or more key management messages comprises receiving an encrypted key management message to be delivered in red transfer to target mode, the method comprising:
decrypting the encrypted key management message, yielding an unencrypted key management message including a target destination identifier; and
delivering the unencrypted key management message to a target communication device corresponding to the target destination identifier.

17. The method of claim 12, wherein the step of receiving one or more key management messages comprises receiving an encrypted key management message to be delivered in black transfer to target mode, the method comprising:
determining a target destination identifier associated with the encrypted key management message; and
delivering the encrypted key management message to a target communication device corresponding to the target destination identifier.

18. The method of claim 17, wherein the step of receiving an encrypted key management message comprises receiving a key management message frame including a key management message field and a target destination field, the key management message field including the encrypted key management message and the target destination field including an encrypted target destination identifier, the step of determining a target destination identifier being accomplished by decrypting the encrypted target destination identifier.
